(19) United States
(12) Patent Application Publication
(10) Pub. No.: US 2021/0287270 A1
(43) Pub. Date: Sep. 16, 2021

(54) INFORMATION PROCESSING SYSTEM, INFORMATION PROCESSING METHOD, AND NON-TRANSITORY COMPUTER-READABLE STORAGE MEDIUM STORING PROGRAM

(71) Applicant: Gurunavi, Inc., Chiyoda-ku (JP)

(72) Inventors: Kiyoshi NISHIZAWA, Chiyoda-ku (JP); Yuki KAMIGAWA, Chiyoda-ku (JP)

(73) Assignee: Gurunavi, Inc., Chiyoda-ku (JP)

(21) Appl. No.: 16/343,141

(22) PCT Filed: Oct. 18, 2017
(86) PCT No.: PCT/IB2017/001260

§ 371 Date: Apr. 18, 2019

(30) Foreign Application Priority Data
Oct. 20, 2016 (JP) 2016-205756
Sep. 20, 2017 (JP) 2017-180137

(51) Int. Cl. G06Q 30/06; G06Q 30/02; G06F 16/9538

(52) U.S. Cl. CPC G06Q 30/0625; G06F 16/9538; G06Q 30/0201; G06Q 30/0643

(57) ABSTRACT

An information processing system includes a memory, communication circuitry and processing circuitry. The memory stores restaurant information containing menu item information for a plurality of menu items at each of a plurality of restaurants. The communication circuitry receives a restaurant search request including a menu item name from a user terminal. The processing circuitry generates a list of the restaurants determined to include at least one menu item corresponding to the menu item name based on the restaurant information, and controls the communication circuitry to transmit a search result page to the user terminal for display. The search result page contains one or more of the at least one menu item corresponding to the menu item name at each of the restaurants in the list of the restaurants.

### RELATED APPLICATION

The present application claims priority to Japanese Patent Application No. 2016-205756, filed Oct. 20, 2016, which is incorporated by reference in its entirety.

### BACKGROUND OF THE INVENTION

### 1. Field

The present disclosure relates to an information processing system, an information processing method and a non-transitory computer-readable storage medium storing a program, which are able to provide information about service facilities, such as restaurants.

### 2. Description of Related Art

A restaurant information providing system may be able to search for a restaurant by using a location, a category, and the like, and provide information about a found restaurant.

For example, Japanese Patent Application Publication No. 2002-310686 (JP 2002-310686 A) describes a car navigation system. As a user inputs the desired type of meal, such as Japanese food, Chinese food and western food, the car navigation system searches for a restaurant by using a place around a current location of a vehicle and the input type of meal as search conditions, and displays a list of restaurants that match the conditions. As the user selects one of the restaurants, the car navigation system displays a list of menu items that are provided by the selected restaurant. As the user selects one menu item from among the list of menu items and specifies visit time, the car navigation system makes a reservation for the restaurant.

### SUMMARY OF THE INVENTION

However, with the technique described in JP 2002-310686 A, it is possible to search for a restaurant by using a restaurant category, such as Japanese food and Chinese food; however, in order to find a menu item that the user wants to eat from among menu items that belong to a selected category, it is required to find a desired menu item by , selecting one restaurant from among a list of the found restaurants and further displaying a list of menu items.

At the time when a user finds a service plan that the user wants to use, such as a banquet plan and an all-you-can-drink plan, as well, the user needs to select one restaurant from among a list of the found restaurants and find a desired service plan by displaying a list of service plans.

The present disclosure provides an information processing system, an information processing method and a non-transitory computer-readable storage medium storing a program, which are able to allow a user to easily select a restaurant by searching for a restaurant by using a menu item name of a menu item that the user wants to eat or a service plan name of a service plan that the user wants to use as a keyword and allowing the user to easily recognize a menu item or service plan of each restaurant, corresponding to the keyword, in a list of the search results.

A first aspect of the present disclosure provides an information processing system. The information processing system includes a memory, communication circuitry and processing circuitry. The memory stores restaurant information containing menu item information for a plurality of menu items at each of a plurality of restaurants. The communication circuitry receives a restaurant search request including a menu item name from a user terminal. The processing circuitry generates a list of the restaurants determined to include at least one menu item corresponding to the menu item name based on the restaurant information. The processing circuitry further controls the communication circuitry to transmit a search result page to the user terminal for display. The search result page contains one or more of the at least one menu item corresponding to the menu item name at each of the restaurants in the list of the restaurants. When the at least one menu item at a restaurant in the list of the restaurants contains three or more menu items corresponding to the menu item name, the search result page includes a predetermined number of the at least one menu item at the restaurant. The predetermined number is two or more and is smaller than a total number of the at least one menu item at the restaurant

With this configuration, the information processing system for example searches for a restaurant by using the menu item name of a menu item that a user wants to eat as a keyword, and contains menu items of each restaurant, corresponding to the keyword, in a list of the search results with a ceiling of the predetermined number. Thus, it is possible to cause the user to easily recognize the menu items. This allows the user to easily select a restaurant. In a list of restaurant information fields, the restaurant information fields of different restaurants are shown, and no different restaurant information fields are generated for one restaurant.

The processing circuitry may select the predetermined number of the at least one menu items at the restaurant in ascending order of a number of characters in a name of each of the at least one menu items.

With this configuration, the information processing system executes control such that each restaurant information field does not become large as much as possible, thus making it possible to prevent a user from being difficult to browse the restaurant information fields.

The processing circuitry may select the predetermined number of the at least one menu item at the restaurant in descending order of a frequency that each of the at least one the menu item is included in the restaurant information.

With this configuration, the information processing system is able to select a menu item that is more frequently included in the restaurant information, that is, a menu item that attracts a lot of attention (highly recommended rating) and provide the menu item to the user.

The processing circuitry may select the predetermined number of the at least one menu item at the restaurant in ascending order of price or in descending order of popularity of each of the at least one menu item.

With this configuration, the information processing system is able to preferentially provide a user with lower-price menu items for the user or popular menu items.

The processing circuitry may determine the predetermined number for each restaurant in the list based on a number of characters of a name of each of the at least one menu item such that a sum of the numbers of characters of the predetermined number of menu items is smaller than or equal to a predetermined number of characters.

With this configuration, the information processing system is able to select a predetermined number of menu items from among a plurality of found menu items within the range in which the sum of the numbers of characters does not exceed a predetermined number of characters.

The menu item information may include an image for each of the menu items that corresponds to the respective menu item. The processing circuitry may determine the predetermined number for each restaurant in the list based on a size of each of the images corresponding to the at least one menu item such that an area in which each of the images corresponding to the predetermined number of menu items is displayed is smaller than or equal to a predetermined area.

With this configuration, the information processing system is able to select a predetermined number of menu items from among the at least one menu item of the restaurant within the range in which the area in which a corresponding image is placed for display does not exceed a predetermined area.

The processing circuitry may determine the predetermined number for each restaurant in the list such that a sum of an amount of information other than corresponding menu item information and an amount of the predetermined number of pieces of the corresponding menu item information, for each restaurant in the list, is smaller than or equal to a predetermined amount.

With this configuration, the information processing system is able to select a predetermined number of menu items from among the at least one menu item of the restaurant within the range in which the sum of the amount of corresponding menu item information and the amount of information other than the corresponding menu item information (such as shop name, genre name, location information and shop introduction article) does not exceed a predetermined amount.

The processing circuitry may generate a restaurant information field for each restaurant in the list in a fixed area.

A second aspect of the present disclosure provides an information processing system. The information processing system includes a memory, communication circuitry and processing circuitry. The memory stores service facility information containing service plan information for a plurality of service plans at each of a plurality of service facilities. The communication circuitry receives a service facility search request including a service plan name from a user terminal. The processing circuitry generates a list of the service facilities determined to include at least one service plan corresponding to the service plan name based on the service facility information. The processing circuitry further controls the communication circuitry to transmit a search result page to the user terminal for display. The search result page contains one or more of the at least one service plan corresponding to the service plan name at each of the service facilities in the list of the service facilities. When the at least one service plan at a service facility in the list of the service facilities contains three or more service plans corresponding to the service plan name, the search result page includes a predetermined number of the at least one service plan at the service facility. The predetermined number is two or more and is smaller than a total number of the at least one service plan at the service facility.

A third aspect of the present disclosure provides an information processing method. The information processing method includes storing restaurant information containing menu item information for a plurality of menu items at each of a plurality of restaurants; and receiving, via communication circuitry of an information processing system, a restaurant search request including a menu item name from a user terminal. The method includes generating, by processing circuitry of the information processing system, a list of the restaurants determined to include at least one menu item corresponding to the menu item name based on the restaurant information; and transmitting, via the communication circuitry, a search result page to the user terminal for display. The search result page contains one or more of the at least one menu item corresponding to the menu item name at each of the restaurants in the list of the restaurants. When the at least one menu item at a restaurant in the list of the restaurants contains three or more menu items corresponding to the menu item name, the search result page includes a predetermined number of the at least one menu item at the restaurant. The predetermined number is two or more and is smaller than a total number of the at least one menu item at the restaurant.

A fourth aspect of the present disclosure provides an information processing method. The information processing method includes storing service facility information containing service plan information for a plurality of service plans at each of a plurality of service facilities; and receiving, via communication circuitry of an information processing system, a service facility search request including a service plan name from a user terminal. The method includes generating, by processing circuitry of the information providing system, a list of the service facilities determined to include at least one service plan corresponding to the service plan name based on the service facility information; and transmitting, via the communication circuitry, a search result page to the user terminal for display, the search result page containing one or more of the at least one service plan corresponding to the service plan name at each of the service facilities in the list of the service facilities. When the at least one service plan at a service facility in the list of the service facilities contains three or more service plans corresponding to the service plan name, the search result page includes a predetermined number of the at least one service plan at the service facility. The predetermined number is two or more and is smaller than a total number of the at least one service plan at the service facility.

A fifth aspect of the present disclosure provides a non-transitory computer-readable storage medium storing a program. The program when executed by a computer causes the computer of an information processing system to perform an information processing method. The information processing method includes storing restaurant information containing menu item information for a plurality of menu items at each of a plurality of restaurants; and receiving a restaurant search request including a menu item name from a user terminal. The information processing method includes generating a list of the restaurants determined to include at least one menu item corresponding to the menu item name based on the restaurant information; and transmitting a search result page to the user terminal for display. The search result page contains one or more of the at least one menu item corresponding to the menu item name at each of the restaurants in the list of the restaurants. When the at least one menu item at a restaurant in the list of the restaurants contains three or more menu items corresponding to the menu item name, the search result page includes a predetermined number of the at least one menu item at the restaurant. The predetermined number is two or more and is smaller than a total number of the at least one menu item at the restaurant.

A sixth aspect of the present disclosure provides a non-transitory computer-readable storage medium storing a program. The program when executed by a computer causes the computer of an information processing system to perform an information processing method. The information processing method includes storing restaurant information containing menu item information for a plurality of menu items at each of a plurality of restaurants; and receiving a restaurant search request including a menu item name from a user terminal. The information processing method includes generating a list of the restaurants determined to include at least one menu item corresponding to the menu item name based on the restaurant information; and transmitting a search result page to the user terminal for display. The search result page contains one or more of the at least one menu item corresponding to the menu item name at each of the restaurants in the list of the restaurants. When the at least one menu item at a restaurant in the list of the restaurants contains three or more menu items corresponding to the menu item name, the search result page includes a predetermined number of the at least one menu item at the restaurant. The predetermined number is two or more and is smaller than a total number of the at least one menu item at the restaurant.

As described above, according to the aspects of the present disclosure, it is possible to search for a restaurant by using the menu item name of a menu item that a user wants to eat as a keyword, cause the user to easily recognize the menu items of each, restaurant, corresponding to the keyword, in a list of the search results, and allow the user to easily select a restaurant. However, this advantageous effect does not limit the present disclosure.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a view that shows the configuration of a restaurant information providing system according to an embodiment of the present disclosure;

FIG. 2 is a view that shows the hardware configuration of a restaurant information providing server according to the embodiment of the present disclosure;

FIG. 3 is a view that shows the configuration of databases included in the restaurant information providing server according to the embodiment of the present disclosure;

FIG. 4 is a flowchart that shows the flow of restaurant information providing process that is executed by the restaurant information providing server according to the embodiment of the present disclosure;

FIG. 5 is a view that shows an example of a restaurant search result page that is displayed on a user terminal in the embodiment of the present disclosure;

FIG. 6 is a view that shows an example of a restaurant search result page that is displayed on a user terminal in another embodiment of the present disclosure; and

FIG. 7 is a view that shows an example of a restaurant search result page that is displayed on a user terminal in further another embodiment of the present disclosure.

### DETAILED DESCRIPTION OF EMBODIMENTS

Hereinafter, an embodiment of the present disclosure will be described with reference to the accompanying drawings.

### Configuration of System

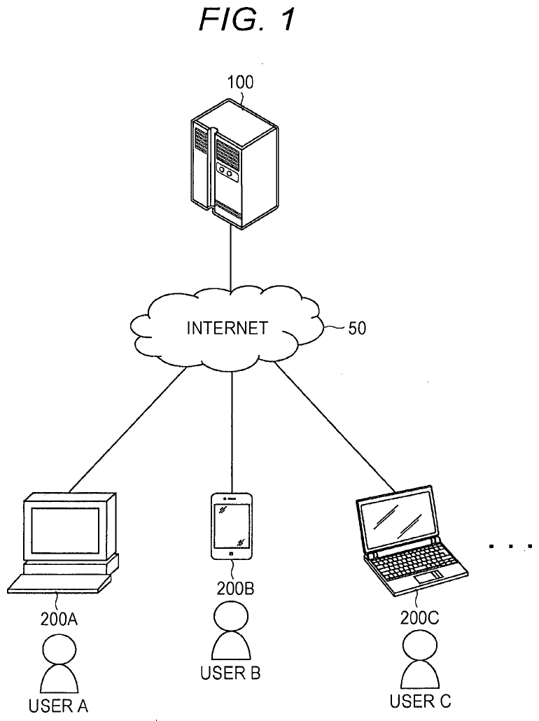

FIG. 1 is a view that shows the configuration of a restaurant information providing system according to the present embodiment.

As shown in FIG. 1, the system includes a restaurant information providing server 100 on the Internet 50, and a plurality of user terminals 200.

The restaurant information providing server 100 is a web server that manages a portal site that provides information about restaurants. The restaurant information providing server 100 is connected to the plurality of user terminals 200 via the Internet 50.

The restaurant information providing server 100 provides a restaurant information search system intended for users of the user terminals 200 on the portal site. Specifically, the restaurant information providing server 100 searches for restaurant information that matches a search condition on the basis of a search request from the user terminal 200, generates a webpage that contains search results, and transmits the webpage to the user terminal 200.

The user terminals 200 (200A, 200B, 200C, . . . ) are terminals that are used by users. Each of the user terminals 200 is, for example, a smartphone, a cellular phone, a tablet personal computer (PC), a notebook PC, a desktop PC, or the like. Each user terminal 200 accesses the restaurant information providing server 100, receives the webpage and displays the webpage on a screen by the use of a browser, or the like.

Each user terminal 200 determines a search condition for searching for a restaurant on the basis of user's operation, and transmits a restaurant search request based on the search condition to the restaurant information providing server 100. In the present embodiment, it is possible to transmit a restaurant search request when the user of the user terminal 200 selects a preset search condition, such as the location (nearest station) and category of a restaurant, and it is also possible to transmit a search request when the user inputs a free word as a search condition. The free word may be, for example, the location, the category or a restaurant name or may be a menu item name. In the following description, the case where a menu item name is a free word as a search condition will be described (hereinafter, such a searching technique is also referred to as menu item name search).

### Hardware Configuration of Restaurant Information Providing Server

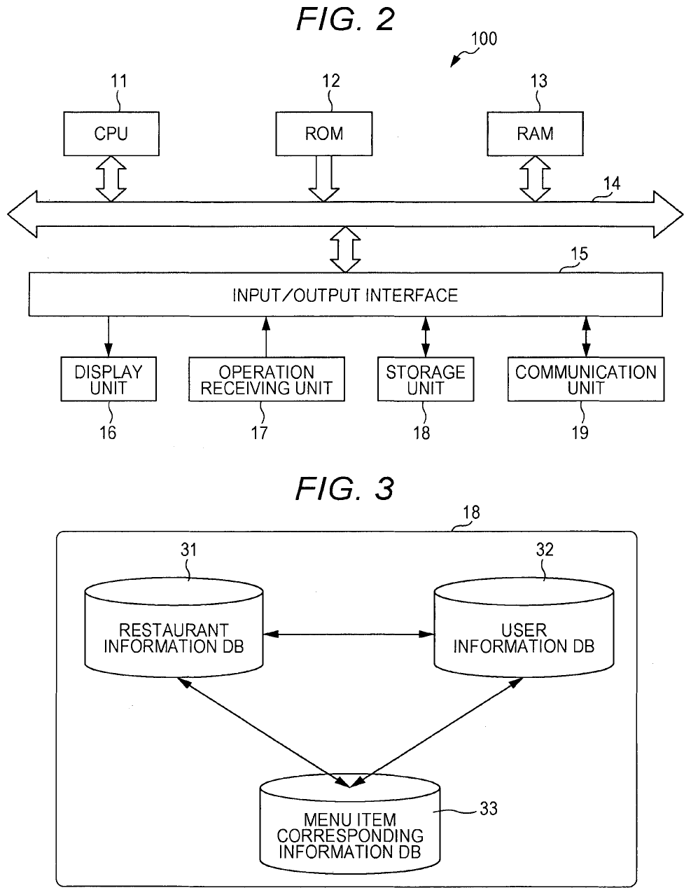

FIG. 2 is a view that shows the hardware configuration of the restaurant information providing server 100. As shown in FIG. 2, the restaurant information providing server 100 includes a central processing unit (CPU) 11, a read only memory (ROM) 12, a random access memory (RAM) 13, an input/output interface 15, and a bus 14 that connects these devices with each other.

The CPU 11 where necessary accesses the RAM 13, and the like, and generally controls all the blocks of the restaurant information providing server 100 while executing various arithmetic processing. The ROM 12 is a nonvolatile memory in which firmware, such as an OS, programs and various parameters to be executed by the CPU 11, is fixedly stored. The RAM 13 is used as a work area, or the like, of the CPU 11, and temporarily holds the OS, various active applications and various in-process data.

A display unit 16, an operation receiving unit 17, a storage unit 18, a communication unit 19, and the like, are connected to the input/output interface 15.

The display unit 16 is, for example, a display device, such as a liquid crystal display (LCD), an organic electroluminescence display (OELD) and a cathode ray tube (CRT).

The operation receiving unit 17 is, for example, a pointing device, such as a mouse, a keyboard, a touch panel, or another input device. When the operation receiving unit 17 is a touch panel, the touch panel may be integrated with the display unit 16.

The storage unit 18 is, for example, a nonvolatile memory, such as a hard disk drive (HDD), a flash memory (solid state drive (SSD)) and another solid-state memory. The OS, various applications and various data are stored in the storage unit 18.

As will be described later, particularly, in the present embodiment, the storage unit 18 includes a restaurant information database, a user information database and a taste information database. The storage unit 18 stores applications and other programs that are required for the process of providing restaurant information in response to a menu item name search request from the user terminal 200 with the use of these databases.

The communication unit 19 is, for example, a network interface card (NIC) for Ethernet or various modules for wireless communication, such as wireless LAN, and carries out communication process with the user terminals 200.

Although not shown in the drawing, the basic hardware configuration of each user terminal 200 is also substantially similar to the hardware configuration of the restaurant information providing server 100.

### Database Configuration of Restaurant Information Providing Server

FIG. 3 is a view that shows the configuration of databases included in the restaurant information providing server 100.

As shown in FIG. 3, the restaurant information providing server 100 includes the restaurant information database 31, the user information database 32 and the menu item corresponding information database 33 in the storage unit 18.

The restaurant information database 31 stores not only the name of a restaurant, the location information of the restaurant and an ID (shop ID) that identifies the restaurant but also category information about the business category and service of the restaurant, a content that introduces the restaurant, that is, information that indicates the feature of the restaurant, such as the advertising text of the restaurant, event information about the restaurant, area information about an area in which the restaurant is located, the address and phone number of the restaurant, image data about the restaurant (that introduce the restaurant), menu item information about menu items that the restaurant provides, information, such as business hours and the website URL, for each restaurant.

The menu item information is information corresponding to menu items that are contained in the site of each restaurant on the portal site, and stores menu item names of a plurality of menu items that each restaurant is able to provide for each restaurant. The menu item information may be, for example, stored for each menu item category, such as appetizer/main, and lunch/dinner/course. When the image data correspond to menu items, each piece of the image data is stored in association with a corresponding one of the pieces of menu item information.

The area information is stored, for example, by prefectures, and may be stored by the unit of a narrower range, for example, by municipalities. The category information, for example, may include not only main categories, such as Japanese food, Chinese food, Italian food, French food and grilled meat, but also more detailed sub-categories, such as yakitori and tempura in Japanese food and pasta and pizza in Italian food.

The user information database 32 stores information about users that respectively have the user terminals 200 and that are users (members) of a restaurant information service through the portal site that the restaurant information providing server 100 provides. Specifically, the user information database 32 stores information, such as user ID, password, name, mail address, phone number, address, age (age bracket), sex, and date of birth, for each user.

The menu item corresponding information database 33 stores a fuzzy search rule, such as notation variability, a synonym, an expression in different name, and a common typographic error, for each menu item name contained in the menu item information.

These databases are consulted with one another where necessary in a restaurant information providing process that is executed by the restaurant information providing server 100 (described later). Particularly, when there is a restaurant search request using a free word from the user terminal 200, the menu item corresponding information database 33 is also consulted together with the menu item information in the restaurant information database 31.

### Operation of Restaurant Information Providing Server

Next, the operation of the thus configured restaurant information providing server 100 will be described. The operation is executed in cooperation between hardware, such as the CPU 11 and communication unit 19 of the restaurant information providing server 100, and software stored in the storage unit 18. In the following description, for the sake of convenience, the CPU 11 executes the operation.

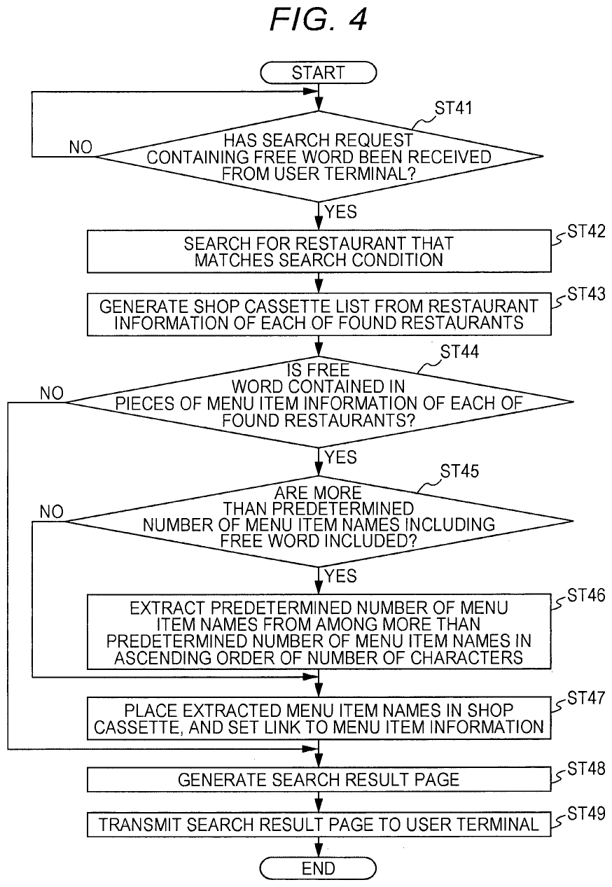

FIG. 4 is a flowchart that shows the flow of restaurant information providing process that is executed by the restaurant information providing server 100.

As shown in FIG. 4, the CPU 11 of the restaurant information providing server 100 initially determines whether a restaurant search request containing a free word as a search condition has been received from the user terminal 200 (step 41).

When it is determined that a search request containing a free word as a search condition has been received (Yes), the CPU 11 searches the restaurant information database 31 for a restaurant that matches the search condition (step 42).

Subsequently, the CPU 11 extracts the restaurant information of each restaurant that matches the search condition from the restaurant information database 31, and generates a list of restaurant information fields (shop cassettes) on the basis of the restaurant information (step 43). Each shop cassette is, for example, generated in the same fixed area.

Subsequently, the CPU 11 determines whether the free word set as the search condition is included in the pieces of menu item information (a list of menu item names) in each of the extracted pieces of restaurant information (step 44).

When it is determined that the free word is not included in the pieces of menu item information in each of the extracted pieces of restaurant information (No), the generated list of shop cassettes is transmitted as a search result page to the user terminal 200 that has transmitted the search request (step 48).

On the other hand, when it is determined that the free word is included in the pieces of menu item information in each of the extracted pieces of restaurant information (Yes), the CPU 11 determines whether more than a predetermined number of menu item names including the free word are included in the pieces of menu item information of each of the extracted pieces of restaurant information (step 45). The predetermined number is, for example, two, three, or the like; however, the predetermined number is not limited to two, three, or the like.

When it is determined that more than the predetermined number of menu item names including the free word are included in the pieces of menu item information (Yes), the CPU 11 extracts the predetermined number of menu items in ascending order of the number of characters from more than the predetermined number of menu item names (step 46). For example, when the predetermined number is two, three menu item names including the free word are included and the numbers of characters of the three menu item names are respectively eight, ten, twelve, the CPU 11 extracts the eight-character menu item name and the ten-character menu item name.

When the predetermined number of menu item names have been extracted from among more than the predetermined number of menu item names in step 46 or when only not more than the predetermined number of menu item names including the free word are included in step 45 (No), the CPU 11 places the predetermined number of menu item names in a shop cassette as corresponding menu item information corresponding to the free word and then sets a hyperlink to menu item list information of the restaurant corresponding to the shop cassette on each menu item name (step 47).

The processes of step 44 to step 47 are executed for each of the restaurants corresponding to the shop cassettes.

The CPU 11 generates a shop cassette list containing the corresponding menu item information as a restaurant search result page (step 48), and transmits the shop cassette list to the user terminal 200 that has transmitted the search request (step 49).

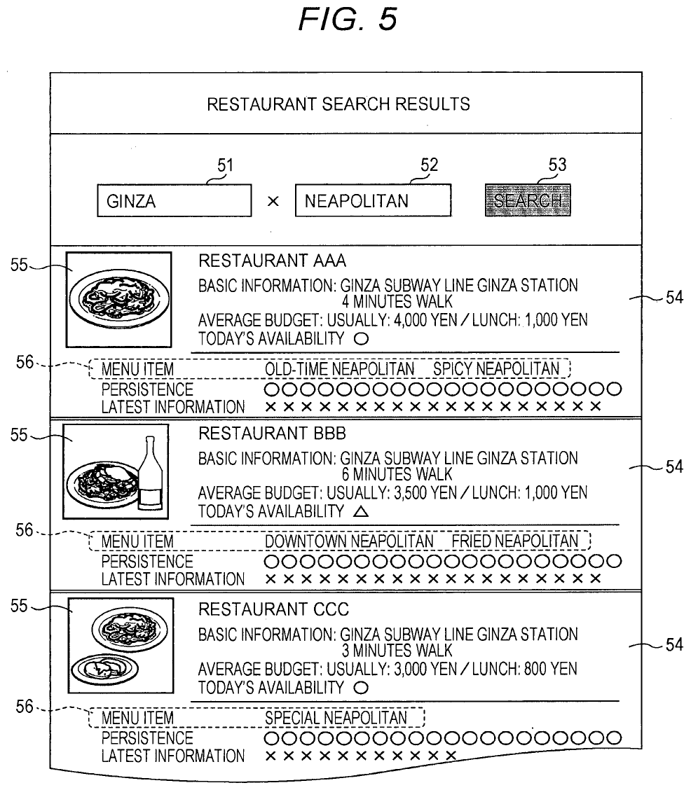

FIG. 5 is a view that shows an example of the restaurant search result page that is generated by the restaurant information providing server 100 and displayed on the display unit of each user terminal 200. FIG. 5 is an example of display in the case where the user terminal 200 is a smartphone. When the user terminal 200 is a notebook PC or a tablet PC, a display mode also varies depending on the size of the display unit.

As shown in FIG. 5, the restaurant search result page contains a list of shop cassettes 54 for respective found restaurants. Only one shop cassette 54 is provided in correspondence with one restaurant. No multiple shop cassettes 54 are provided in correspondence with the same restaurant. An area/station name input box 51, a free word input box 52 and a search button 53 are provided on, for example, the upper side of the list of the shop cassettes 54.

These input boxes and search button 53 are also displayed on a search request page at the time when the user terminal 200 transmits a search request to the restaurant information providing server 100, and are reflected directly onto the search result page. FIG. 5 shows an example of the search result page in the case where “Ginza” is input to the area/station name input box 51 on the search request page, “Neapolitan” is input to the free word input box 52 and then the search request has been transmitted by depressing the search button 53.

Each shop cassette 54 contains not only basic information, such as restaurant name, access information to a restaurant, average budget information and same-day seat availability information, and a restaurant introduction image 55 but also corresponding menu item information 56 containing the free word input to the free word input box 52.

The corresponding menu item information 56 is extracted from among the pieces of menu item information of the restaurant information of each restaurant as described above. For example, when “Neapolitan” is input as a free word, the corresponding menu item information of each restaurant, including the “Neapolitan”, is extracted and displayed as the corresponding menu item information 56. In one embodiment, images of the menu items of the restaurants may be analyzed to determine whether any of the menu items match the inputted free word.

Specifically, more than the predetermined number (two) of menu items including “Neapolitan” are included in each of the pieces of menu item information of the restaurant corresponding to the top shop cassette 54 (restaurant AAA) and the menu item information of the restaurant corresponding to the second from the top (restaurant BBB) in FIG. 5, two menu items (“Old-time Neapolitan” and “Spicy Neapolitan” for restaurant AAA and “Downtown Neapolitan” and “Fried Neapolitan” for restaurant BBB) are extracted and placed from among the corresponding menu items in ascending order of the number of characters. With this configuration, it is possible to prevent a situation in which a large number of pieces of corresponding menu item information are displayed in a shop cassette 54 and a user is difficult to browse the corresponding menu item information. The number of extracted menu items, in one embodiment, may be determined based on a display screen size and/or type of the user terminal.

Further, load on the restaurant information providing server 100 may be reduced by allowing the user to identify at least some of the menu items at a restaurant that correspond to the inputted free word from the display of the restaurant search results without requiring individual requests for menu item information from each of the restaurants in the restaurant search results. Operation of the user terminal may also be improved due to a reduction in the load time and the amount of data transfer required to switch between different information for display.

On the other hand, only one menu item including “Neapolitan” (“Special Neapolitan”) is included in the menu item information of the restaurant corresponding to the third shop cassette 54 from the top (restaurant CCC), so the only one menu item is placed directly.

As described above, in the present embodiment, only one shop cassette 54 is generated for one restaurant. That is, a list of the shop cassettes 54 is generated in the case where a menu item name includes a search condition; however, the list of the shop cassettes 54 is absolutely displayed as a restaurant search result page. Even if a plurality of menu items including a menu item name input as the free word are included in the pieces of menu item information of one restaurant, no multiple shop cassettes 54 of the same restaurant are generated in correspondence with the plurality of menu items. The pieces of corresponding menu item information are collectively placed in one shop cassette 54 with a ceiling of the predetermined number. Therefore, each user is allowed to select a restaurant where the user wants to go (in which the user is interested) while consulting the corresponding menu item information 56 by browsing the list of the shop cassettes 54.

As described above, the corresponding menu item information 56 contains a hyperlink to a menu item information page of the restaurant information of each restaurant. Therefore, when the user terminal 200 is clicked or tapped on the corresponding menu item information 56 within a shop cassette, the page shifts to the menu item information page of the restaurant corresponding to the shop cassette.

A hyperlink to the top page of the restaurant information of each restaurant is set on each restaurant name within the corresponding shop cassette. When the user terminal 200 is clicked or tapped on the restaurant name, the page shifts to the top page of the corresponding restaurant.

The CPU 11 of the restaurant information providing server 100 may extract and place an image specified by each restaurant as an image having a higher priority or an image selected randomly as the restaurant introduction image 55 from among, for example, the plurality of images stored in the restaurant information database 31. Instead, when there is an image corresponding to a menu item name included in the free word, the CPU 11 may extract and place the image. Therefore, in this case, even when a restaurant that is placed on a search result page is the same, the restaurant introduction image 55 can be different when a menu item name included in the free word is different. Thus, the restaurant information providing server 100 is able to allow the user of the user terminal 200 to visually recognize a menu item that the user wants to eat (in which the user is interested) together with the corresponding menu item information 56.

### Conclusion

As described above, according to the present embodiment, the restaurant information providing server 100 searches for a restaurant by using the menu item name of a menu item that a user wants to eat as a keyword, and places menu items of each restaurant, corresponding to the keyword, in a list of the search results with a ceiling of the predetermined number. Thus, it is possible to cause the user to easily recognize the menu items. This allows the user to easily select a restaurant. In addition, it is possible to cause the user to select a desired restaurant that provides a desired menu item in one step unlike the existing technique for causing a user to select a restaurant from among a list of found restaurants and then find a desired menu item by displaying a list of menu items (two steps), so the load on the restaurant information providing server 100 is reduced.

### Alternative Embodiments

The present disclosure is not limited to the above-described embodiment. The above-described embodiment may be variously modified without departing from the scope of the disclosure.

In the above-described embodiment, when more than the predetermined number of menu items including a search keyword are included in the menu item information of each restaurant, the restaurant information providing server 100 extracts the predetermined number of menu items from among those menu items in ascending order of the number of characters. However, the condition for extracting the predetermined number of menu items is not limited to the number of characters. For example, when more than the predetermined number of menu items including a search keyword are included in the menu item information of each restaurant, the CPU 11 may extract the predetermined number of menu items in descending order of a frequency that the menu item is included in the restaurant information of each restaurant (such as restaurant introduction article, recommended information and event information). With this configuration, the restaurant information providing server 100 is able to extract a menu item that is more frequently included in the restaurant information, that is, a menu item that attracts a lot of attention (highly recommended rating) and provide the menu item to the user.

The CPU 11 may extract the predetermined number of menu items from among the plurality of found menu items in ascending order of price or in descending order of popularity. The price or popularity contained in the menu item information is referenced. With this configuration, the restaurant information providing server 100 is able to preferentially provide a user with lower-price menu items for the user or popular menu items.

In the above-described embodiment, the predetermined number that is the condition based on which menu items are extracted in the case where more than menu items including a search keyword are included in the menu item information of each restaurant is fixed (for example, two). However, the restaurant information providing server 100 may determine the predetermined number (two or larger) on the basis of found menu items.

For example, the CPU 11 may determine the predetermined number for each shop cassette 54 on the basis of the number of characters of each of the plurality of found menu items such that the sum of the numbers of characters of the predetermined number of menu items is smaller than or equal to a predetermined number of characters. The predetermined number of characters is, for example, 20 characters, 30 characters, 40 characters, or the like; however, the predetermined number of characters is not limited to these number of characters. In this case, the CPU 11 may sequentially combine a plurality of found menu items, for example, two by two or three by three and adds up the numbers of characters of them, and may extract a combination such that the most number of menu items are placed as long as the sum of the numbers of characters is smaller than or equal to the predetermined number of characters. With this configuration, the restaurant information providing server 100 is able to extract a predetermined number of menu items from among a plurality of found menu items within the range in which the sum of the numbers of characters does not exceed the predetermined number of characters.

When the restaurant introduction image 55 corresponding to a menu item is used as the corresponding menu item information 56, the CPU 11 may determine the predetermined number for each shop cassette 54 on the basis of the size of each of the images 55 corresponding to the plurality of found menu items such that the area in which each of the images 55 corresponding to the predetermined number of menu items is placed is smaller than or equal to a predetermined area. For example, the CPU 11 may determine the predetermined number such that the sum of the horizontal sizes (horizontal resolutions) of the images 55 falls within a predetermined percentage (for example, 80%, or the like) of the horizontal length of the shop cassette 54 on the assumption that the images 55 are placed horizontally in line within the shop cassette 54. When the size of an image varies among menu items, the CPU 11 may combine images corresponding to a plurality of found menu items, for example, two by two, three by three or four by four, add up the horizontal lengths of those images, including a margin between the adjacent images, and extract a combination such that the most number of images 55 are placed within the length that is smaller than or equal to the predetermined percentage of the horizontal length of the shop cassette 54. With this configuration, the restaurant information providing server 100 is able to extract a predetermined number of menu items from among a plurality of found menu items within the range in which the area in which corresponding images are placed do not exceed the predetermined area.

The CPU 11 may determine the predetermined number for each shop cassette 54 such that the sum of the amount of information other than the pieces of corresponding menu item information 56 (such as restaurant name, basic information, average budget, persistence information and latest information, shown in FIG. 5) and the amount of the predetermined number of the pieces of corresponding menu item information 56, included in each shop cassette 54, is smaller than or equal to a predetermined amount. Therefore, for example, when the area of each shop cassette 54 is fixed, the number of pieces (the predetermined number) of corresponding menu item information 56 relatively increases as the information other than the corresponding menu item information 56 reduces, and the predetermined number relatively reduces as the information other than the corresponding menu item information 56 increases. In this case as well, similarly, the CPU 11 may extract a combination of a plurality of menu items (the number of characters or the size of each image) such that the most number of pieces of corresponding menu item information 56 are placed in an area except an area in which information other than the corresponding menu item information 56 is placed within the shop cassette 54. With this configuration, the restaurant information providing server 100 is able to extract a predetermined number of menu items from among a plurality of found menu items within the range in which the sum of the amount of corresponding menu item information 56 and the amount of information other than the corresponding menu item information 56 does not exceed the predetermined amount.

In the above-described embodiment, at the time when the user terminal 200 transmits a restaurant search request to the restaurant information providing server 100, a search request using various free words including a restaurant name or a menu item name is transmitted, and the restaurant information providing server 100 searches all the pieces of restaurant information in the restaurant information database 31 as a search target for a restaurant that matches the free word. Instead, the free word limited to a menu item name may be allowed to be input. In this case, the restaurant information providing server 100 searches only the menu item information in the restaurant information database 31 as a search target for the input menu item name. For this reason, the load on the restaurant information providing server 100 is reduced.

In the above-described embodiment, in each shop cassette of a search result page, corresponding menu item information is placed as a menu item name (text information). Instead, the corresponding menu item information may be placed as an image (photo) instead of text information. This image is an image stored as the menu item information in the restaurant information database 31 in association with the menu item name. In this case, the restaurant introduction image 55 may be placed in the shop cassette 54 in addition to an image as the corresponding menu item information or the restaurant introduction image 55 does not need to be placed.

In the above-described embodiment, a restaurant is illustrated as a service facility. However, a service facility is not limited to a restaurant. The present disclosure is similarly applicable to various service facilities. Examples of the various service facilities include an accommodation facility, such as a hotel and an inn, a facility for the wedding (a church, a hotel, a restaurant, a shrine, or the like), various sport facilities, such as a golf course, an entertainment facility, such as a karaoke box and a bowling alley, and the like.

In the above-described embodiment, the case where a menu item name of a restaurant is input as a search condition is described. When the service facility is able to provide a plurality of service plans, a service plan name may be set as a search condition instead of the menu item name. Hereinafter, an embodiment of this case will be described by taking the case where a service facility is a restaurant as an example.

In this case, the restaurant information providing server 100 stores plan information about service plans that each restaurant is able to provide, in the restaurant information database 31. The service plan is a plan that a predetermined meal, drink, seat, or the like, is provided at a predetermined price, and includes, for example, an all-you-can-drink plan, a banquet plan, a boys-night-out plan, a girls-night-out plan, various course plans, a private room plan, a chartered plan, an anniversary plan, and the like. The service plan information contains information that indicates service plan names, prices, images and other plan details about those service plans.

The flow of the restaurant information providing process that is executed by the restaurant information providing server 100 in this case is similar to the above-described embodiment except that a menu item name in the above-described embodiment is replaced with a service plan name.

That is, when the CPU 11 of the restaurant information providing server 100 has received a restaurant search request using a service plan name as the free word from the user terminal 200, the CPU 11 generates a list of restaurant information fields (shop cassettes) of which the service plan information contains a service plan corresponding to the service plan name.

The CPU 11 transmits a search result page to the user terminal 200. The search result page contains corresponding service plan information that shows at least one service plan corresponding to the service plan name set as the search condition on the list of the shop cassettes among the service plans that each restaurant is able to provide.

At this time, when a restaurant of which the service plan information contains three or more service plans corresponding to the service plan name set as the search condition has been found, the CPU 11 extracts a predetermined number of service plans from among the plurality of service plans, and controls the above-described search result page such that corresponding service plan information that indicates the extracted service plans is contained in a corresponding one of the shop cassettes. The predetermined number is two or more, and is smaller than the number of the found service plans.

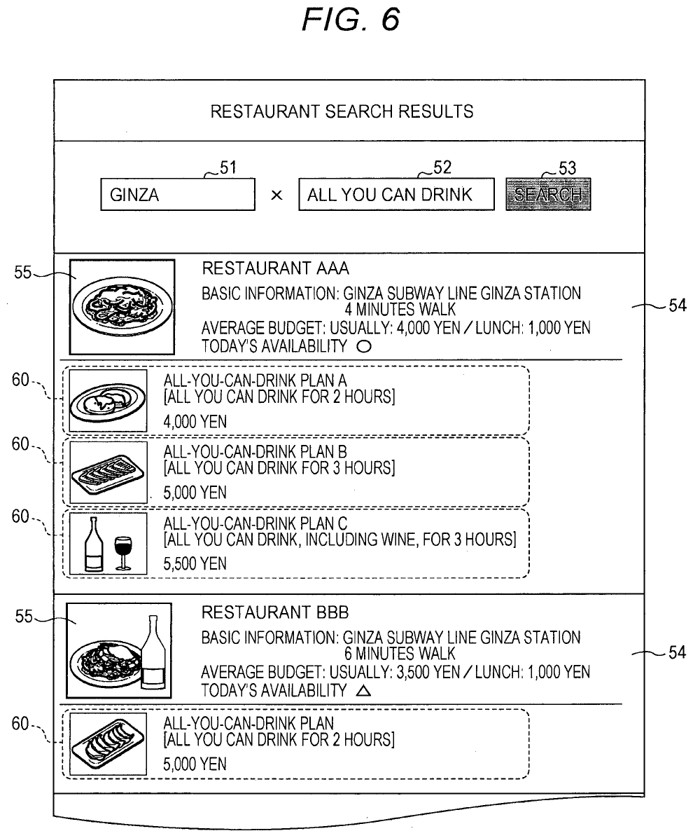

FIG. 6 is a view that shows an example of a restaurant search result page that is displayed on the user terminal 200 in this embodiment.

FIG. 6 shows an example of a search result page in the case where “Ginza” is input to the area/station name input box 51 on the search request page, “all you can drink” is input to the free word input box 52 and then the search request has been transmitted by depressing the search button 53.

As shown in FIG. 6, as in the case of the above-described embodiment, each shop cassette 54 contains not only the basic information of a corresponding one of restaurants but also corresponding service plan information 60 containing the free word “all you can drink” input to the free word input box 52.

The corresponding service plan information 60 is extracted from among the pieces of service plan information of the restaurant information of each restaurant. When “all you can drink” is input as a free word, the corresponding service plan information of each restaurant, including the “all you can drink”, is extracted and displayed as the corresponding service plan information 60.

Specifically, more than the predetermined number (for example, three) of service plans including “all you can drink” are included in each of the pieces of service plan information of the restaurant corresponding to the top shop cassette 54 (restaurant AAA) in FIG. 6, three all-you-can-drink plans are extracted and placed from among the corresponding service plans in accordance with a predetermined condition (for example, in ascending order of the number of characters, in ascending order of price, or the like). Each of the pieces of corresponding service plan information 60 contains, for example, an image corresponding to each service plan and information that indicates each service plan name, a price and other plan details.

With this configuration, it is possible to prevent a situation in which a large number of pieces of corresponding service plan information 60 are displayed in a shop cassette 54 and a user is difficult to browse the corresponding service plan information 60. Further, load on the restaurant information providing server 100 may be reduced by allowing the user to identify at least some of the service plans at a restaurant that correspond to the inputted free word from the display of the restaurant search results without requiring individual requests for service plan information from each of the restaurants in the restaurant search results. Operation of the user terminal may also be improved due to a reduction in the load times and the amount of data transfer required to switch between different information for display.

On the other hand, only one service plan including “all you can drink” is included in the service plan information of the restaurant corresponding to the second shop cassette 54 from the top (restaurant BBB), so the only one service plan is placed directly.

In this way, when a service plan name is set as a search condition instead of a menu item name as well, it is possible to cause a user to easily recognize service plans and allow the user to easily select a restaurant with a process similar to the above-described embodiment.

Input of a service plan name as the search condition by a user is not limited to input to the input box 52 in text. For example, a plurality of choices regarding the service plan may be provided on the search request page, and a user may input a search condition by selecting any one from among the plurality of choices. The choices are provided by, for example, a pull-down menu, check boxes, radio buttons, or the like.

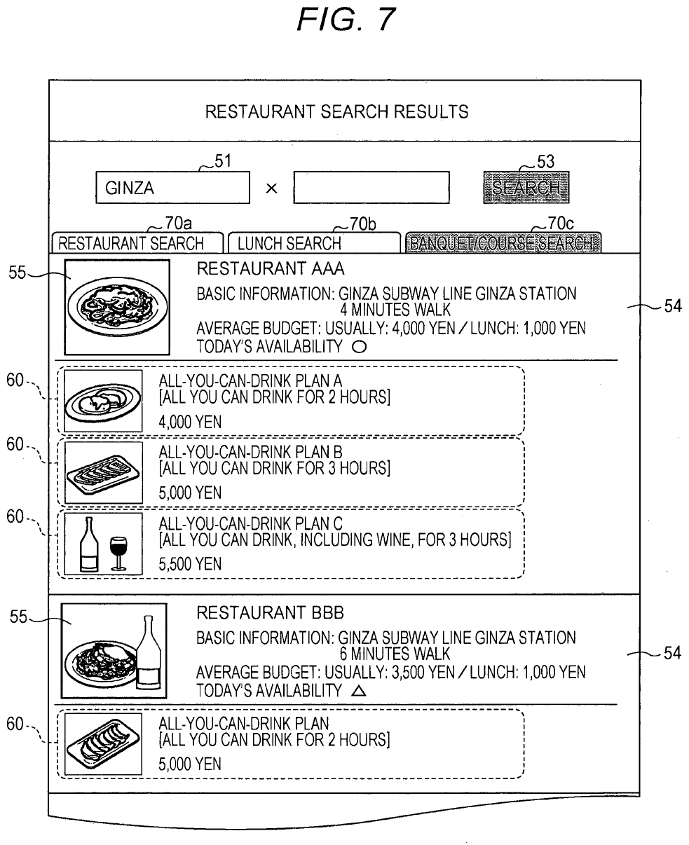

Furthermore, tabs may be used as choices for inputting the search condition. FIG. 7 is a view that shows an example of a restaurant search result page that is displayed on each user terminal 200 in this case.

As shown in FIG. 7, a “restaurant search” tab 70a, a “lunch search” tab 70b and a “banquet/course search” tab 70c are provided on the page as tabs for displaying restaurant search results. The “restaurant search” tab 70a is a tab for displaying a list of search results (shop cassettes 54) of all the restaurants corresponding to a search condition input to the input box 51. The “lunch search” tab 70b is a tab for displaying a list of search results of restaurants that open for lunch among the search results of all the restaurants. The “banquet/course search” tab 70c is a tab for displaying a list of search results of restaurants that are able to provide service plans regarding a banquet/course among the search results of all the restaurants.

When the user terminal 200 has selected the “banquet/course search” tab 70c on the page, the restaurant information providing server 100 receives the selection information as a restaurant search request using a service plan name as a search condition. The restaurant information providing server 100 extracts a predetermined number of pieces of service plan information from among more than the predetermined number (for example, three) of pieces of service plan information of each restaurant in a corresponding one of the shop cassettes 54 on the “banquet/course search” tab 70c as shown in FIG. 7, and displays a predetermined number of pieces of the corresponding service plan information 60, which indicate the extracted pieces of service plan information.

In the process in the case where the service plan name is set as a search condition, when a service facility is an accommodation facility, examples of service plans include “plan including breakfast”, “plan including breakfast and dinner”, “in-room meal plan”, “plan without meals”, “late checkout plan”, “plan with open-air bath”, and the like.

When the service facility is a facility for the wedding, examples of service plans include “plan with only a wedding ceremony”, “nonreligious wedding ceremony plan”, “family wedding plan”, “maternity wedding plan”, “special plan”, “plan with tasting”, and the like.

Among the features recited in the appended claims of the present application, the present disclosure described as an information processing method is that at least one computer, or the like, automatically executes the steps of the information processing method through information processing implemented by software, and is not the one that a human performs with the use of a device, such as a computer. That is, the information processing method is an information processing method that is implemented by computer software and is not a method that a human operates a calculation tool named computer.

The above disclosure also encompasses the embodiments listed below. (1) An information processing system (100), including a memory (18) that stores restaurant information containing menu item information for a plurality of menu items at each of a plurality of restaurants; communication circuitry (19) that receives a restaurant search request including a menu item name from a user terminal (200A, 200B, 200C); and processing circuitry (11) that generates a list of the restaurants determined to include at least one menu item corresponding to the menu item name based on the restaurant information, and that controls the communication circuitry to transmit a search result page to the user terminal for display, the search result page containing one or more of the at least one menu item corresponding to the menu item name at each of the restaurants in the list of the restaurants, wherein when the at least one menu item at a restaurant in the list of the restaurants contains three or more menu items corresponding to the menu item name, the search result page includes a predetermined number of the at least one menu item at the restaurant, the predetermined number being two or more and being smaller than a total number of the at least one menu item at the restaurant.

(2) The information processing system according to feature (1), in which the processing circuitry selects the predetermined number of the at least one menu item at the restaurant in ascending order of a number of characters in a name of each of the at least one menu items.

(3) The information processing system according to feature (1) or (2), wherein the processing circuitry selects the predetermined number of the at least one menu item at the restaurant in descending order of a frequency that each of the at least one menu item is included in the restaurant information.

(4) The information processing system according to any of features (1) to (3), wherein the processing circuitry selects the predetermined number of the at least one menu item at the restaurant in ascending order of price or in descending order of popularity of each of the at least one menu item.

(5) The information processing system according to any of features (1) to (4), wherein the processing circuitry determines the predetermined number for each restaurant in the list based on a number of characters of a name of each of the at least one menu item such that a sum of the numbers of characters of the predetermined number of menu items is smaller than or equal to a predetermined number of characters.

(6) The information processing system according to any of features (1) to (5), wherein the menu item information includes an image for each of the menu items that corresponds to the respective menu item, and the processing circuitry determines the predetermined number for each restaurant in the list based on a size of each of the images corresponding to the at least one menu item such that an area in which each of the images corresponding to the predetermined number of menu items is displayed is smaller than or equal to a predetermined area.

(7) The information processing system according to any of features (1) to (6), wherein the processing circuitry determines the predetermined number for each restaurant in the list such that a sum of an amount of information other than corresponding menu item information and an amount of the predetermined number of pieces of the corresponding menu item information, for each restaurant in the list, is smaller than or equal to a predetermined amount.

(8) The information processing system according to any of features (1) to (7), wherein the processing circuitry generates a restaurant information field for each restaurant in the list in a fixed area.

(9) An information processing system (100), including a memory (18) that stores service facility information containing service plan information for a plurality of service plans at each of a plurality of service facilities; communication circuitry (19) that receives a service facility search request including a service plan name from a user terminal; and processing circuitry (11) that generates a list of the service facilities determined to include at least one service plan corresponding to the service plan name based on the service facility information, and that controls the communication circuitry to transmit a search result page to the user terminal for display, the search result page containing one or more of the at least one service plan corresponding to the service plan name at each of the service facilities in the list of the service facilities, wherein when the at least one service plan at a service facility in the list of the service facilities contains three or more service plans corresponding to the service plan name, the search result page includes a predetermined number of the at least one service plan at the service facility, the predetermined number being two or more and being smaller than a total number of the at least one service plan at the service facility.

(10) An information processing method, including storing restaurant information containing menu item information for a plurality of menu items at each of a plurality of restaurants; receiving, via communication circuitry (19) of an information processing system, a restaurant search request including a menu item name from a user terminal (200A, 200B, 200C); generating, by processing circuitry (11) of the information processing system, a list of the restaurants determined to include at least one menu item corresponding to the menu item name based on the restaurant information; transmitting, via the communication circuitry, a search result page to the user terminal for display, the search result page containing one or more of the at least one menu item corresponding to the menu item name at each of the restaurants in the list of the restaurants; and when the at least one menu item at a restaurant in the list of the restaurants contains three or more menu items corresponding to the menu item name, the search result page includes a predetermined number of the at least one menu item at the restaurant, the predetermined number being two or more and being smaller than a total number of the at least one menu item at the restaurant.

(11) An information processing method, including storing service facility information containing service plan information for a plurality of service plans at each of a plurality of service facilities; receiving, via communication circuitry (19) of an information processing system, a service facility search request including a service plan name from a user terminal (200A, 200B, 200C); generating, by processing circuitry (11) of the information processing system, a list of the service facilities determined to include at least one service plan corresponding to the service plan name based on the service facility information; transmitting, via the communication circuitry, a search result page to the user terminal for display, the search result page containing one or more of the at least one service plan corresponding to the service plan name at each of the service facilities in the list of the service facilities; and when the at least one service plan at a service facility in the list of the service facilities contains three or more service plans corresponding to the service plan name, the search result page includes a predetermined number of the at least one service plan at the service facility, the predetermined number being two or more and being smaller than a total number of the at least one service plan at the service facility.

(12) A non-transitory computer-readable storage medium storing a program, the program which when executed by a computer of an information processing system causing the computer to perform an information processing method, the information processing method including storing restaurant information containing menu item information for a plurality of menu items at each of a plurality of restaurants; receiving a restaurant search request including a menu item name from a user terminal; generating a list of the restaurants determined to include at least one menu item corresponding to the menu item name based on the restaurant information; transmitting a search result page to the user terminal for display, the search result page containing one or more of the at least one menu item corresponding to the menu item name at each of the restaurants in the list of the restaurants; and when the at least one menu item at a restaurant in the list of the restaurants contains three or more menu items corresponding to the menu item name, the search result page includes a predetermined number of the at least one menu item at the restaurant, the predetermined number being two or more and being smaller than a total number of the at least one menu item at the restaurant.

(13) A non-transitory computer-readable storage medium storing a program, the program which when executed by a computer causing the computer to perform an information processing method, the information processing method including storing service facility information containing service plan information for a plurality of service plans at each of a plurality of service facilities; receiving a service facility search request including a service plan name from a user terminal; generating a list of the service facilities determined to include at least one service plan corresponding to the service plan name based on the service facility information; transmitting a search result page to the user terminal for display, the search result page containing one or more of the at least one service plan corresponding to the service plan name at each of the service facilities in the list of the service facilities; and when the at least one service plan at a service facility in the list of the service facilities contains three or more service plans corresponding to the service plan name, the search result page includes a predetermined number of the at least one service plan at the service facility, the predetermined number being two or more and being smaller than a total number of the at least one service plan at the service facility.

### Drawings Legends

### DRAWINGS

FIG. 1
1/USER A
2/USER B
3/USER C
FIG. 2
15/INPUT/OUTPUT INTERFACE
16/DISPLAY UNIT
17/OPERATION RECEIVING UNIT
18/STORAGE UNIT
19/COMMUNICATION UNIT
FIG. 3
31/RESTAURANT INFORMATION DB
32/USER INFORMATION DB
33/MENU ITEM CORRESPONDING INFORMATION DB
FIG. 4
ST41/HAS SEARCH REQUEST CONTAINING FREE WORD BEEN RECEIVED FROM USER TERMINAL?
ST42/SEARCH FOR RESTAURANT THAT MATCHES SEARCH CONDITION
ST43/GENERATE SHOP CASSETTE LIST FROM RESTAURANT INFORMATION OF EACH OF FOUND RESTAURANTS
ST44/IS FREE WORD CONTAINED IN PIECES OF MENU ITEM INFORMATION OF EACH OF FOUND RESTAURANTS?
ST45/ARE MORE THAN PREDETERMINED NUMBER OF MENU ITEM NAMES INCLUDING FREE WORD INCLUDED?
ST46/EXTRACT PREDETERMINED NUMBER OF MENU ITEM NAMES FROM AMONG MORE THAN PREDETERMINED NUMBER OF MENU ITEM. NAMES IN ASCENDING ORDER OF NUMBER OF CHARACTERS
ST47/PLACE EXTRACTED MENU ITEM NAMES IN SHOP CASSETTE, AND SET LINK TO MENU ITEM INFORMATION
ST48/GENERATE SEARCH RESULT PAGE
ST49/TRANSMIT SEARCH RESULT PAGE TO USER TERMINAL
FIG. 5
1/RESTAURANT SEARCH RESULTS
51/GINZA
52/NEAPOLITAN
53/SEARCH
2/RESTAURANT AAA

BASIC INFORMATION: GINZA SUBWAY LINE GINZA STATION 4 MINUTES WALK

AVERAGE BUDGET: USUALLY: 4,000 YEN/LUNCH: 1,000 YEN TODAY'S AVAILABILITY O
3/MENU ITEM OLD-TIME NEAPOLITAN SPICY NEAPOLITAN

PERSISTENCE

LATEST INFORMATION
4/RESTAURANT BBB

BASIC INFORMATION: GINZA SUBWAY LINE GINZA STATION 6 MINUTES WALK

AVERAGE BUDGET: USUALLY: 3,500 YEN/LUNCH: 1,000 YEN

TODAY'S AVAILABILITY Δ
5/MENU ITEM DOWNTOWN NEAPOLITAN FRIED NEAPOLITAN

PERSISTENCE

LATEST INFORMATION
6/RESTAURANT CCC

BASIC INFORMATION: GINZA SUBWAY LINE GINZA STATION 3 MINUTES WALK

AVERAGE BUDGET: USUALLY: 3,000 YEN/LUNCH: 800 YEN

TODAY'S AVAILABILITY O
7/MENU ITEM SPECIAL NEAPOLITAN

PERSISTENCE

LATEST INFORMATION
FIG. 6
1/RESTAURANT SEARCH RESULTS
51/GINZA
52/ALL YOU CAN DRINK
53/SEARCH
2/RESTAURANT AAA

BASIC INFORMATION: GINZA SUBWAY LINE GINZA STATION 4 MINUTES WALK

AVERAGE BUDGET: USUALLY: 4,000 YEN/LUNCH: 1,000 YEN

TODAY'S AVAILABILITY O
3/ALL-YOU-CAN-DRINK PLAN A [ALL YOU CAN DRINK FOR 2 HOURS] 4,000 YEN
4/ALL-YOU-CAN-DRINK PLAN B [ALL YOU CAN DRINK FOR 3 HOURS] 5,000 YEN
5/ALL-YOU-CAN-DRINK PLAN C [ALL YOU CAN DRINK, INCLUDING WINE, FOR 3 HOURS]

5,500 YEN
6/RESTAURANT BBB

BASIC INFORMATION: GINZA SUBWAY LINE GINZA STATION 6 MINUTES WALK

AVERAGE BUDGET: USUALLY: 3,500 YEN/LUNCH: 1,000 YEN

TODAY'S AVAILABILITY Δ
7/ALL-YOU-CAN-DRINK PLAN [ALL YOU CAN DRINK FOR 2 HOURS]

5,000 YEN
FIG. 7
1/RESTAURANT SEARCH RESULTS
51/GINZA
53/SEARCH
70a/RESTAURANT SEARCH
70b/LUNCH SEARCH
70c/BANQUET/COURSE SEARCH
2/RESTAURANT AAA

BASIC INFORMATION: GINZA SUBWAY LINE GINZA STATION 4 MINUTES WALK

AVERAGE BUDGET: USUALLY: 4,000 YEN/LUNCH: 1,000 YEN

TODAY'S AVAILABILITY O
3/ALL-YOU-CAN-DRINK PLAN A [ALL YOU CAN DRINK FOR 2 HOURS]

4,000 YEN
4/ALL-YOU-CAN-DRINK PLAN B [ALL YOU CAN DRINK FOR 3 HOURS]

5,000 YEN
5/ALL-YOU-CAN-DRINK. PLAN C [ALL YOU CAN DRINK, INCLUDING WINE, FOR 3 HOURS]

5,500 YEN
6/RESTAURANT BBB

BASIC INFORMATION: GINZA SUBWAY LINE GINZA STATION 6 MINUTES WALK

AVERAGE BUDGET: USUALLY: 3,500 YEN/LUNCH: 1,000 YEN

TODAY'S AVAILABILITY Δ
7/ALL-YOU-CAN-DRINK PLAN [ALL YOU CAN DRINK FOR 2 HOURS]

5,000 YEN

1. An information processing system, comprising:
a memory that stores restaurant information containing menu item information for a plurality of menu items at each of a plurality of restaurants;
communication circuitry that receives a restaurant search request including a menu item name from a user terminal; and
processing circuitry that generates a list of the restaurants determined to include at least one menu item corresponding to the menu item name based on the restaurant information, and that controls the communication circuitry to transmit a search result page to the user terminal for display, the search result page containing one or more of the at least one menu item corresponding to the menu item name at each of the restaurants in the list of the restaurants, wherein
when the at least one menu item at a restaurant in the list of the restaurants contains three or more menu items corresponding to the menu item name, the search result page includes a predetermined number of the at least one menu item at the restaurant, the predetermined number being two or more and being smaller than a total number of the at least one menu item at the restaurant.

2. The information processing system according to claim 1, wherein
the processing circuitry selects the predetermined number of the at least one menu item at the restaurant in ascending order of a number of characters in a name of each of the at least one menu items.

3. The information processing system according to claim 1, wherein
the processing circuitry selects the predetermined number of the at least one menu item at the restaurant in descending order of a frequency that each of the at least one menu item is included in the restaurant information.

4. The information processing system according to claim 1, wherein
the processing circuitry selects the predetermined number of the at least one menu item at the restaurant in ascending order of price or in descending order of popularity of each of the at least one menu item.

5. The information processing system according to claim 1, wherein
the processing circuitry determines the predetermined number for each restaurant in the list based on a number of characters of a name of each of the at least one menu item such that a sum of the numbers of characters of the predetermined number of menu items is smaller than or equal to a predetermined number of characters.

6. The information processing system according to claim 1, wherein
the menu item information includes an image for each of the menu items that corresponds to the respective menu item, and
the processing circuitry determines the predetermined number for each restaurant in the list based on a size of each of the images corresponding to the at least one menu item such that an area in which each of the images corresponding to the predetermined number of menu items is displayed is smaller than or equal to a predetermined area.

7. The information processing system according to claim 1, wherein
the processing circuitry determines the predetermined number for each restaurant in the list such that a sum of an amount of information other than corresponding menu item information and an amount of the predetermined number of pieces of the corresponding menu item information, for each restaurant in the list, is smaller than or equal to a predetermined amount.

8. The information processing system according to claim 1, wherein
the processing circuitry generates a restaurant information field for each restaurant in the list in a fixed area.

9. An information processing system, comprising:
a memory that stores service facility information containing service plan information for a plurality of service plans at each of a plurality of service facilities;
communication circuitry that receives a service facility search request including a service plan name from a user terminal; and
processing circuitry that generates a list of the service facilities determined to include at least one service plan corresponding to the service plan name based on the service facility information, and that controls the communication circuitry to transmit a search result page to the user terminal for display, the search result page containing one or more of the at least one service plan corresponding to the service plan name at each of the service facilities in the list of the service facilities, wherein
when the at least one service plan at a service facility in the list of the service facilities contains three or more service plans corresponding to the service plan name, the search result page includes a predetermined number of the at least one service plan at the service facility, the predetermined number being two or more and being smaller than a total number of the at least one service plan at the service facility.

10. An information processing method, comprising:
storing restaurant information containing menu item information for a plurality of menu items at each of a plurality of restaurants;
receiving, via communication circuitry of an information processing system, a restaurant search request including a menu item name from a user terminal;
generating, by processing circuitry of the information processing system, a list of the restaurants determined to include at least one menu item corresponding to the menu item name based on the restaurant information;
transmitting, via the communication circuitry, a search result page to the user terminal for display, the search result page containing one or more of the at least one menu item corresponding to the menu item name at each of the restaurants in the list of the restaurants; and
when the at least one menu item at a restaurant in the list of the restaurants contains three or more menu items corresponding to the menu item name, the search result page includes a predetermined number of the at least one menu item at the restaurant, the predetermined number being two or more and being smaller than a total number of the at least one menu item at the restaurant.

11. An information processing method, comprising:
storing service facility information containing service plan information for a plurality of service plans at each of a plurality of service facilities;
receiving, via communication circuitry of an information processing system, a service facility search request including a service plan name from a user terminal;
generating, by processing circuitry of the information providing system, a list of the service facilities determined to include at least one service plan corresponding to the service plan name based on the service facility information;
transmitting, via the communication circuitry, a search result page to the user terminal for display, the search result page containing one or more of the at least one service plan corresponding to the service plan name at each of the service facilities in the list of the service facilities; and
when the at least one service plan at a service facility in the list of the service facilities contains three or more service plans corresponding to the service plan name, the search result page includes a predetermined number of the at least one service plan at the service facility, the predetermined number being two or more and being smaller than a total number of the at least one service plan at the service facility.

12. A non-transitory computer-readable storage medium storing a program, the program which when executed by a computer of an information processing system causing the computer to perform an information processing method, the information processing method comprising:
storing restaurant information containing menu item information for a plurality of menu items at each of a plurality of restaurants;
receiving a restaurant search request including a menu item name from a user terminal;
generating a list of the restaurants determined to include at least one menu item corresponding to the menu item name based on the restaurant information;
transmitting a search result page to the user terminal for display, the search result page containing one or more of the at least one menu item corresponding to the menu item name at each of the restaurants in the list of the restaurants; and
when the at least one menu item at a restaurant in the list of the restaurants contains three or more menu items corresponding to the menu item name, the search result page includes a predetermined number of the at least one menu item at the restaurant, the predetermined number being two or more and being smaller than a total number of the at least one menu item at the restaurant.

13. A non-transitory computer-readable storage medium storing a program, the program which when executed by a computer causing the computer to perform an information processing method, the information processing method comprising:
storing service facility information containing service plan information for a plurality of service plans at each of a plurality of service facilities;
receiving a service facility search request including a service plan name from a user terminal;
generating a list of the service facilities determined to include at least one service plan corresponding to the service plan name based on the service facility information;
transmitting a search result page to the user terminal for display, the search result page containing one or more of the at least one service plan corresponding to the service plan name at each of the service facilities in the list of the service facilities; and
when the at least one service plan at a service facility in the list of the service facilities contains three or more service plans corresponding to the service plan name, the search result page includes a predetermined number of the at least one service plan at the service facility, the predetermined number being two or more and being smaller than a total number of the at least one service plan at the service facility.
